(19) United States
(12) Patent Application Publication
(10) Pub. No.: US 2026/0348839 A1
(43) Pub. Date: Nov. 5, 2026

(54) METHOD FOR CALIBRATING A SPECTROMETER DEVICE OF A BATCH OF SPECTROMETER DEVICES

(71) Applicant: TRINAMIX GMBH, Ludwigshafen Am Rhein (DE)

(72) Inventors: Michael HANKE, Ludwigshafen am Rhein (DE); Robert LOVRINCIC, Ludwigshafen am Rhein (DE); Andre HORSAK, Ludwigshafen am Rhein (DE); Tobias LAUSCH, Ludwigshafen am Rhein (DE)

(21) Appl. No.: 19/102,869

(22) PCT Filed: Sep. 13, 2023
(86) PCT No.: PCT/EP23/75110

§ 371 Date: Feb. 11, 2025

(30) Foreign Application Priority Data
Sep. 14, 2022 (EP) 22195498.5

(51) Int. Cl. G01N 21/31

(52) U.S. Cl. CPC G01N 21/31; G01N 2201/0636; G01N 2201/105; G01N 2201/127

(57) ABSTRACT

Disclosed herein is a method for calibrating a spectrometer device of a batch of spectrometer devices. The spectrometer device includes at least one detector device including at least one optical element configured for separating incident light into a spectrum of constituent wavelength components and further including a plurality of photosensitive elements, where the method includes the following steps:
a) at least one system characterization step including determining line spread functions at corresponding wavelengths by comparing at least one spectrum measured by using the spectrometer device with at least one reference spectrum;
b) at least one resolution homogenization step including for each wavelength converting a resolution of the line spread function to a pre-defined target resolution for a corresponding wavelength, where the target resolution for each wavelength is a pre-defined target batch resolution value for the respective wavelength.

### TECHNICAL FIELD

The present invention relates to a method and a system for calibrating a spectrometer device of a batch of spectrometer devices. Further, the present invention relates to a computer program and a computer-readable storage medium for performing the method for calibrating a spectrometer device of a batch of spectrometer devices. The method and devices can, in particular, be used for calibrating spectrometer devices used for investigation in the infrared spectral region, specifically in the near infrared and the mid infrared spectral regions. However, other spectrometer devices used for optical investigation are also feasible.

### BACKGROUND ART

Spectrographic methods are widely used in research, industry and customer applications, enabling multiple applications such as optical analysis and/or quality control. Use cases can be found for food, farming, pharma, medical, life sciences and many more. Various methods are available, such as photometry, absorption, fluorescence and Raman spectrometry, enabling qualitative and/or quantitative sample analysis. These methods usually involve mapping of spectral information, such as an irradiance of a sample, at a specific wavelength onto a specific physical section of the spectrographic device, for example detector pixels, time intervals or others.

A production of large quantities of spectrometer devices, for example when moving from the manufacturing of single pieces to series production, generally requires high demands for the spectral homogeneity between different spectrometer devices. Specifically, in order to achieve accurate predictive models irrespective of an employed spectrometer device from a given spectrometer fleet, quantitative and/or qualitative inferences from spectral data generally need to be reproducible between different spectrometer devices. For example, key parameters such as spectral resolution, straylight contributions and/or detector characteristics of the different spectrometer devices either need to be identical or a process of mitigation is required.

In general, there are different possibilities of achieving identical model predictions across a spectrometer fleet. As an example, homogeneity on the production level ensures that all spectrometer devices are produced to a very high degree of precision such that all key parameters characterizing the spectral performance of the spectrometer devices are virtually identical across the spectrometer fleet. However, this may poses immense requirements either to production tolerances and/or to production rejects.

As another example, homogeneity through model calibration may be achieved by calibrating the trainable model specifically for each spectrometer device in the spectrometer fleet. However, this approach generally requires high effort since either each spectrometer device must be calibrated for every potential use case it may be used on and/or each individual spectrometer device may be only suitable for a specific use cases it is calibrated for.

Despite the advantages achieved by known method and devices, several technical challenges remain. Specifically, trainable models for spectroscopic data may suffer in their prediction accuracy if they are fed with spectral data for the exact same sample that are not identical to the noise-limited regime. As an example, spectral data obtained with different spectrometer devices differing in their instrumental resolution generally provides such non-identical spectral data. On the modeling side, this technical challenge may only be overcome by specific training of the trainable model to account for differences between different spectrometer devices. However, such a procedure becomes increasingly infeasible with a growing number of spectrometer devices the trainable model shall be used for. There is a need for a global, use-case-independent calibration and correction scheme on the individual spectrometer device level that enables fleet homogenization of the resulting spectral data to the degree that trainable models produce accurate results across the entire fleet of spectrometer devices.

J. C. Weatheran et al., “Adapting Raman Spectra from Laboratory Spectrometers to Portable Detection Libraries”, APPLIED SPECTROSCOPY, Volume 67, Number 2, 2013 describes processing Raman spectral data collected with high-resolution laboratory spectrometers into a format suitable for importing as a user library on a 1064 nm DeltaNu first generation, field-deployable spectrometer prototype. The two laboratory systems used are a 1064 nm Bruker Fourier transform (FT)-Raman spectrometer and a 785 nm Kaiser dispersive spectrometer.

D. Kakkad et al.,“HARMON!: Characterising the line spread function with a tunable Fabry-Perot etalon”, Proc. SPIE 11451, Advances in Optical and Mechanical Technologies for Telescopes and Instrumentation IV, 114515W, 13 Dec. 2020 describes a tunable Fabry-Pérot design which is used to characterise the lines spread function (LSF) of the High Angular Resolution Monolithic Optical and Near-Infrared integral field spectrograph (HARMONI).

E. Emsellem et al., “The PHANGS-MUSE survey: Probing the chemo-dynamical evolution of disc galaxies”, A&A Volume 659, March 2022, A191 describes the PHANGS-MUSE survey, a program using the MUSE integral field spectrograph (IFS) at the ESO VLT to map 19 massive nearby star-forming disc galaxies.

US 2007/0046933 A1 describes a spectroscopic process in which a sample for producing a test spectral line or spectrum of at least one component contained in the sample is stimulated and the transmitted and/or emitted electromagnetic rays are used to create the test spectral line or spectrum.

EP 0 982 582 A1 describes a suppression of effects of unwanted components such as H20 and C02 in spectral data measured by a spectrometer. Data is modified so that its resolution matches that of the instrument, is filtered to allow for perturbing effects of the sample, and is subtracted from the measured sample spectrum to provide corrected output data.

U.S. Pat. No. 5,303,165 A describes a spectrometric instrument which exhibits an intrinsic profile for a sharp spectral line produces profile data for narrow spectral lines.

### Problem to Be Solved

It is therefore desirable to provide methods and devices which at least partially address above-mentioned technical challenges regarding the calibration of spectrometer devices. Specifically, a method and a system for calibrating a spectrometer device of a batch of spectrometer devices shall be proposed which provide a global and use-case-independent calibration ensuring high accuracy and reliability of the results of the spectrometer devices.

### SUMMARY

This problem is addressed by a method and a system for calibrating a spectrometer device of a batch of spectrometer devices, by a computer program and a computer-readable storage medium with the features of the independent claims. Advantageous embodiments which might be realized in an isolated fashion or in any arbitrary combinations are listed in the dependent claims as well as throughout the specification.

As used herein, the terms “have”, “comprise” or “include” or any arbitrary grammatical variations thereof are used in a non-exclusive way. These terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements. Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a method for calibrating a spectrometer device of a batch of spectrometer devices is disclosed.

The term “spectrometer device” as used herein is a broad term and is to be given its ordinary and customary meaning to a person of ordinary skill in the art and is not to be limited to a special or customized meaning. The term specifically may refer, without limitation, to a device capable of optically analyzing at least one sample, thereby generating at least one item of information on at least one spectral property of the sample. Specifically, the term may refer to a device which is capable of recording a signal intensity with respect to a corresponding wavelength of a spectrum or a partition thereof, such as a wavelength interval, wherein the signal intensity may, preferably, be provided as an electrical signal which may be used for further evaluation. An optical element, specifically comprising at least one wavelength-selective element, such as an optical filter and/or a dispersive element, may be used for separating incident light into a spectrum of constituent wavelength components whose respective intensities are determined by employing a detector device. In addition, a further optical element may be used which can be designed for receiving incident light and transferring the incident light to the optical element. The spectrometer device, generally, may be operable in a reflective mode and/or may be operable in a transmissive mode. For possible embodiment of the spectrometer device, reference is made to the description of the spectrometer device as will be outlined in further detail below.

The term “calibrating”, the process also being referred to as “calibration”, as used herein is a broad term and is to be given its ordinary and customary meaning to a person of ordinary skill in the art and is not to be limited to a special or customized meaning. The term specifically may refer, without limitation, to a process of at least one of determining, correcting and adjusting measurement inaccuracies at the spectrometer device. The result of the calibration process, often also referred to as the “item of calibration information”, may also be or comprise at least one item of information on the result of the calibration process, such as a calibration function, a calibration factor, a calibration matrix or the like, e.g. for transforming one or more measured values into one or more calibrated or “true” values. Measurement inaccuracies may, as an example, arise from uncertainties in wavelength determination and/or from intrinsic and/or extrinsic interferences on measurement signals of the spectrometer device. Calibrating the spectrometer device may comprise at least one of a wavelength calibration, a stray light calibration, a dark current calibration, a test of a spectral resolution. The calibration, specifically each of the calibrations, may comprise at least one two-step process, wherein, in a first step, information on a deviation of a measurement signal of the spectrometer device from a known standard is determined, wherein, in a second step, this information is used for correcting and/or adjusting the measurement signal of the spectrometer device in order to reduce, minimize and/or eliminate the deviation. The calibration may comprise applying the item of calibration information, for example to a measurement signal and/or to a measurement spectrum of the spectrometer device. A calibration of the spectrometer device may improve and/or maintain accuracy of measurements performed with the calibrated spectrometer device. Alternatively or additionally, the calibrating may comprise preparing the measurement signal and/or the measurement spectrum of the spectrometer device in such a way that the measurement signal and/or the measurement spectrum may be used for further analysis and/or evaluation, such as by preparing the measurement signal and/or the measurement spectrum as input data for one or more trainable models analyzing the measurement signal and/or the measurement spectrum. The calibrating may ensure that the measurement signal and/or the measurement spectrum is suitable for being analyzed by the trainable model in order to provide accurate results.

The calibrating of the spectrometer device specifically may be performed at a manufacturer's site of the spectrometer device manufacturer. The calibrating, however, may also be performed in the field, such as after setup of the spectrometer device at the site of use and/or for maintenance purposes.

The term “batch” as used herein is a broad term and is to be given its ordinary and customary meaning to a person of ordinary skill in the art and is not to be limited to a special or customized meaning. The term specifically may refer, without limitation, to a plurality of spectrometer device being manufactured in a common manufacturing process. The common manufacturing process may comprise a series of manufacturing steps, wherein the series of manufacturing steps yield the plurality of assembled spectrometer devices. The common manufacturing process may specifically be a common manufacturing process in terms of time and/or in terms of manufacturing steps. The batch of spectrometer device may be manufactured in a timely overlapping fashion. Alternatively or additionally, the batch of spectrometer devices may be manufactured in subsequent manufacturing processes, wherein the subsequent manufacturing processes comprise the same series of manufacturing steps. The term “batch of spectrometer device” may also be referred to as “fleet of spectrometer devices” or any grammatical variation thereof.

The spectrometer device comprises at least one detector device. Specifically, when calibrating the spectrometer device, a calibration of the detector device comprised by the spectrometer device may be necessary and may be performed. The term “detector device” as used herein is a broad term and is to be given its ordinary and customary meaning to a person of ordinary skill in the art and is not to be limited to a special or customized meaning. The term specifically may refer, without limitation, to an arbitrary device or combination of devices capable of recording and/or monitoring incident light. The detector device may be responsive to incident illumination and may be configured for generating an electrical signal indicating an intensity of the illumination. The detector device may be sensitive in one or more of a visible spectral range, an ultraviolet spectral range or the infrared spectral range, specifically a near infrared spectral range (NIR). The detector device specifically may be or may comprise at least one optical sensor, e.g. an optical semiconductor sensor. As an example, specifically in case the detector device is sensitive in the infrared spectral range, such as in the near infrared spectral range, the semiconductor sensor may be or may comprise at least one semiconductor sensor comprising at least one material selected from the group consisting of Si, PbS, PbSe, Ge, InGaAs, extended-InGaAs, InSb or HgCdTe. As an example, the detector device may comprise at least one photodetector such as at least one CCD or CMOS device. The detector device specifically may comprise at least one detector array comprising a plurality of pixelated sensors, wherein each of the pixelated sensors is configured to detect at least a portion of at least one of the constituent wavelength components.

The detector device comprises at least one optical element configured for separating incident light into a spectrum of constituent wavelength components. The term “optical element” as used herein is a broad term and is to be given its ordinary and customary meaning to a person of ordinary skill in the art and is not to be limited to a special or customized meaning. The term specifically may refer, without limitation, to an arbitrary element or a combination of elements suitable for one or more of transmitting, reflecting, deflecting or scattering light in a wavelength-dependent manner. The optical element may further be configured, specifically after separating incident light into the spectrum of constituent wavelength components, for transmitting the spectrum onto the detector device. Specifically, the wavelength-dependent transmission, reflections, deflection or scattering of incident light at the optical element may result in a spatial separation of the constituent wavelength components of the spectrum which may be transmitted directly or indirectly onto the detector device.

The term “light” as used herein is a broad term and is to be given its ordinary and customary meaning to a person of ordinary skill in the art and is not to be limited to a special or customized meaning. The term specifically may refer, without limitation, to a partition of electromagnetic radiation which is, usually, referred to as “optical spectral range” and which comprises one or more of a visible spectral range, an ultraviolet spectral range and an infrared spectral range.

The terms “ultraviolet spectral” or “UV”, generally, refer to electromagnetic radiation having a wavelength of 1 nm to 380 nm, preferably of 100 nm to 380 nm. The term “visible”, generally, refers to a wavelength of 380 nm to 760 nm. The terms “infrared” or “IR”, generally, refer to a wavelength of 760 nm to 1000 μm, wherein a wavelength of 760 nm to 3 μm is, usually, denominated as “near infrared” or “NIR” while the wavelength of 3 μ to 15 μm is, usually, denoted as “mid infrared” or “MidIR” and the wavelength of 15 μm to 1000 μm as “far infrared” or “FIR”.

The term “spectrum” as used herein is a broad term and is to be given its ordinary and customary meaning to a person of ordinary skill in the art and is not to be limited to a special or customized meaning. The term specifically may refer, without limitation, to a partition of the optical spectral range, in particular, the IR spectral range, especially at least one of the NIR or the MidIR spectral ranges, being investigated by the spectrometer device. Each part of the spectrum may be constituted by an optical signal which is defined by a signal wavelength and the corresponding signal intensity. The term “constituent wavelength component” as used herein is a broad term and is to be given its ordinary and customary meaning to a person of ordinary skill in the art and is not to be limited to a special or customized meaning. The term specifically may refer, without limitation, to the optical signal forming part of the spectrum. Specifically, the optical signal may comprise the signal intensity corresponding to the respective wavelength or wavelength interval.

The detector device further comprises a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component.

The term “photosensitive element” as used herein is a broad term and is to be given its ordinary and customary meaning to a person of ordinary skill in the art and is not to be limited to a special or customized meaning. The term specifically may refer, without limitation, to an individual optical sensor comprised by the detector device, wherein each optical sensor has at least one photosensitive area configured for recording a photoresponse of the photosensitive element by generating at least one output signal that depends on an intensity of a portion of one of the constituent wavelength components impinging on the particular photosensitive area. The at least one photosensitive area as comprised by each individual optical sensor may, especially, be a single, uniform area which is designated for receiving incident light impinging on the photosensitive area. The at least one output signal may, in particular, be used as the detector signal and can, preferably, be provided to an external evaluation unit for further evaluation.

The term “detector signal” as used herein is a broad term and is to be given its ordinary and customary meaning to a person of ordinary skill in the art and is not to be limited to a special or customized meaning. The term specifically may refer, without limitation, to a signal generated by at least one detector, specifically to the at least one output signal of the photosensitive element. The at least one output signal may be selected from at least one of an electronic signal and an optical signal. The at least one output signal may be an analogue signal and/or a digital signal. The output signals for adjacent photosensitive elements can be generated simultaneously, or in a temporally successive manner. By way of example, during a row scan or a line scan, it can be feasible to generate a sequence of output signals which correspond to the series of the photosensitive elements which may be arranged in a line. In addition, the individual photosensitive elements may, preferably, be active pixel sensors which may be adapted to amplify the output signals prior to providing them as detector signals to an external evaluation unit. For this purpose, the photosensitive element may comprise one or more signal processing devices, such as one or more filters and/or analogue-digital-converters for processing and/or preprocessing the electronic signals.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion.

The method may comprise further method steps which are not listed.

The method comprises the following steps:
a) at least one system characterization step comprising determining line spread functions at corresponding wavelengths by comparing at least one spectrum measured by using the spectrometer device with at least one reference spectrum;
b) at least one resolution homogenization step comprising for each wavelength converting a resolution of the line spread function to a pre-defined target resolution for a corresponding wavelength, wherein the target resolution for each wavelength is a pre-defined target batch resolution value for the respective wavelength.

The term “system characterization” as used herein is a broad term and is to be given its ordinary and customary meaning to a person of ordinary skill in the art and is not to be limited to a special or customized meaning. The term specifically may refer, without limitation, to a process of determining one or more system characteristics of the spectrometer device. The system characterization step may comprise determining system characteristics related to the spectral data obtained by using the spectrometer device. For example, the system characteristics may comprise one or more of spectral resolution, straylight contributions and/or detector characteristics. The system characterization step may be performed with each spectrometer device in the fleet of spectrometer devices. The system characterization step may determine the one or more system characteristics for each spectrometer devices in the fleet of spectrometer devices. The system characteristics may vary for the spectrometer devices in the fleet of spectrometer devices. A lowest performing spectrometer device, for example a lowest spectral resolution of a specific spectrometer device, may be used as a lower boundary for the following homogenization step. The system characterization step may specifically be performed to estimate an instrumental line spread function which provides an estimate of the spectral resolution as a function of the wavelength. The system characterization step may comprise determining the system characteristics by analyzing spectral data obtained by using the spectrometer device. For example, the characterization step may specifically comprise analyzing spectral data obtained by using the spectrometer device, such as analyzing the spectrum measured by using the spectrometer device and the reference spectrum, to obtain the system characteristics of the spectrometer device.

The term “reference spectrum” as used herein is a broad term and is to be given its ordinary and customary meaning to a person of ordinary skill in the art and is not to be limited to a special or customized meaning. The term specifically may refer, without limitation, to a spectrum, specifically a spectrum as defined above, obtained by measuring a reference object with a reference spectrometer device. The reference object may be an object of known spectral characteristics, such as known reflection and/or transmission characteristics. The reference spectrometer device measuring the reference object may be a high-resolution spectrometer device. The reference spectrum may be obtained prior to the performance of the method. The reference spectrum may be provided by a manufacturer of the reference object and/or by a manufacturer of the spectrometer device. As an example, the reference spectrum may be measured by the manufacturer of the reference object providing the reference object and the reference spectrum. Alternatively or additionally, the reference spectrum may be measured by the manufacturer of the spectrometer device measuring the reference object with a high-resolution spectrometer device. The reference spectrum may be stored in a database and may be retrieved when performing step a).

The term “line spread function” as used herein is a broad term and is to be given its ordinary and customary meaning to a person of ordinary skill in the art and is not to be limited to a special or customized meaning. The term specifically may refer, without limitation, to an item of information describing a distribution of responses of the photosensitive elements to incident light having a specific wavelength. Specifically, the line spread function may describe a relationship of the detector signal of every photosensitive element to a fixed monochromatic excitation. The line spread function may be used for estimating a spectral resolution of the spectrometer device as a function of the wavelength. Specifically, the line spread function may describe a distribution of responses of the plurality of photosensitive elements to incident light having a specific wavelength. The line spread function may comprise, for the specific wavelength, a discrete distribution and/or a continuous distribution of responses of the plurality of photosensitive elements to incident light having the specific wavelength. The distribution of responses may be used to estimate the spectral resolution of the spectrometer at the specific wavelength, such as by fitting one or more resolution functions to the distribution. The line spread function may be determined for at least two specific wavelength within the entire wavelength interval of the spectrometer device. The line spread function across the entire wavelength interval may be obtained by interpolating between the line spread functions, specifically between the spectral resolutions estimated by the line spread functions, at the specific wavelengths.

The term “resolution”, also referred to as “spectral resolution”, as used herein is a broad term and is to be given its ordinary and customary meaning to a person of ordinary skill in the art and is not to be limited to a special or customized meaning. The term specifically may refer, without limitation, to a measure of the spectrometer's ability of resolving features in the measured spectrum. Specifically, the resolution may be a minimum wavenumber, wavelength or frequency difference between two lines in a spectrum that can be distinguished.

The system characterization step may comprise:
a1) illuminating, by using at least one broadband light source, the spectrometer device through at least one optical interferometer;
a2) determining for the plurality of photosensitive elements a plurality of detectors signals depending on the illumination through the optical interferometer in step a1); and
a3) determining the line spread function from the plurality of detector signals.

The term “broadband light source” as used herein is a broad term and is to be given its ordinary and customary meaning to a person of ordinary skill in the art and is not to be limited to a special or customized meaning. The term specifically may refer, without limitation, to a device emitting light in a broad spectral range, such as light having a spectral width of at least 5 nm, specifically at least 10 nm, e.g. a spectral width of 10 nm to 3000 nm. The broad spectral range of the broadband light source may comprise at least one of the visible spectral range, the ultraviolet spectral range and the infrared spectral range. Light used for the typical purposes of the present invention may, in particular, comprise light in the IR spectral range, specifically in at least one of the NIR or the MidIR spectral ranges, more specifically having a wavelength of 1 μm to 5 μm, even more specifically of 1 μm to 3 μm, and in the visible spectral range, specifically having a wavelength of 380 nm to 760 nm. For example the broadband light source may comprise a thermal emitter emitting light in the visible spectral range, in the NIR and in the MidIR, such as from 600 nm to 3000 nm. The broadband light source may, as an example, comprise at least one of: an incandescent lamp; a blackbody radiator; an electric filament; a light emitting diode.

The term “optical interferometer” as used herein is a broad term and is to be given its ordinary and customary meaning to a person of ordinary skill in the art and is not to be limited to a special or customized meaning. The term specifically may refer, without limitation, to a device or a combination of devices for enabling superposition of light, specifically of light in the optical spectral range, to cause an effect of interference of the superimposed light. For example, the optical interferometer may be configured for splitting incident light into at least two beams of light and, further, for causing a phase shift of the split light beams relative to each other. The optical interferometer may further be configured for combining the phase shifted light beams such that the light beams superimpose and interfere with each other. The optical interferometer may comprise at least one interferometer selected from the group consisting of: a Michelson interferometer; a Fabry-Pérot interferometer; a cube corner interferometer.

In step a1), a main frequency of the optical interferometer, specifically a main transmission frequency and/or a main reflection frequency of the optical interferometer, may be varied over a predetermined spectral range. In step a2), the plurality of detectors signals may be determined depending on the main frequency of the optical interferometer. In step a3), the line spread function may be determined by comparing the main frequency of the optical interferometer, specifically the main transmission frequency and/or the main reflection frequency of the optical interferometer, with at least one of a pixel position and an identification number of the plurality of photosensitive elements generating intensity peaks in the plurality of detector signals associated with the main frequency. The term “pixel position” as used herein is a broad term and is to be given its ordinary and customary meaning to a person of ordinary skill in the art and is not to be limited to a special or customized meaning. The term specifically may refer, without limitation, to an arbitrary item of location information of the photosensitive element in the detector device. The pixel information may describe a position of the photosensitive element in the detector device by using one or more of an absolute position information and a relative position information, specifically in one, two or even three dimensions. The term “identification number” as used herein is a broad term and is to be given its ordinary and customary meaning to a person of ordinary skill in the art and is not to be limited to a special or customized meaning. The term specifically may refer, without limitation, to a numerical or alpha-numerical item of information uniquely identifying each photosensitive element comprised by the detector device. For example, the photosensitive elements of the detector device may be numbered with respect to an order of appearance in the detector device. However, other options for identifying the photosensitive elements in the detector device are also feasible.

The optical interferometer, as an example, may comprise at least one beam splitting device for splitting incident light into at least two illumination paths. The optical interferometer may further comprise at least one scanning mirror in a first illumination path and at least one stationary mirror in a second illumination path. In the method, specifically in steps a1) and a2), the scanning mirror may be moved along the first illumination path, wherein the stationary mirror may be kept stationary. Specifically, in step a2), the plurality of detector signals may be determined for a plurality of positions of the scanning mirror in the first illumination path. The plurality of positions of the scanning mirror may be different from each other. Step a3) may further comprise correlating the plurality of detector signals with the plurality of positions of the scanning mirror. Specifically, in step a3), the plurality of detector signals correlated to the plurality of positions of the scanning mirror may be used for determining the line spread function.

Step a3) may comprise processing the plurality of detector signals determined in the step a2), thereby obtaining a plurality of processed detector signals. The determining of the line spread function in step a3) may comprise determining the line spread function from the plurality of processed detector signals. The processing of the plurality of detector signals may specifically comprise transforming the plurality of detector signals. As an example, the plurality of detector signals may be transformed by using at least one Fourier transformation.

The system characterization step comprising steps a1) to a3) may comprise feeding the spectrometer device with light from the optical interferometer with the at least one spectrally continuous broadband light source and using the detector device of the spectrometer device to form a Fourier-transform spectrometer. The resulting interferogram, i.e. the measured intensity as a function of the mirror position of the interferometer, may be to compute the line spread functions of the spectrometer device at every wavelength position.

Alternatively or additionally, the system characterization step may comprise
ai) illuminating the spectrometer device by using monochromatic light sources with central wavelengths which are spread across a wavelength range of the spectrometer device to be calibrated;
aii) determining the line spread function by comparing a known spectrum of the monochromatic light sources with the spectrum measured by using the spectrometer device.

The term “monochromatic light source” as used herein is a broad term and is to be given its ordinary and customary meaning to a person of ordinary skill in the art and is not to be limited to a special or customized meaning. The term specifically may refer, without limitation, to a device emitting light with one single wavelength or in a spectral range of no more than 100 nm, specifically no more than at least 10 nm, more specifically no more than 5 nm. The monochromatic light source may be configured for emitting light within at least one of the visible spectral range, the ultraviolet spectral range and the infrared spectral range. The monochromatic light sources may comprise, as an example, a continuous emitter, such as a broadband light source, in conjunction with bandpass filters or a monochromatic emitter, such as a laser or the like. An intrinsic spectral width of the monochromatic light sources may be comparable to the line spread function at the corresponding wavelength. The monochromatic light sources may specifically comprise a plurality of monochromatic light sources.

Step aii) may comprise broadening the known spectrum of the monochromatic light sources by using kernel convolution with a theoretical line spread function. Step aii) may specifically comprise adjusting parameters of a theoretical kernel until the broadened spectrum of the monochromatic light sources matches the measured spectrum. The adjusted kernel parameters may be used to approximate the line spread function at this wavelength. The theoretical kernel may be at least one kernel selected from the group consisting of: a Gaussian kernel with only one free parameter; Lorentzian profile; Moffat profile; or Voigt profile; asymmetric kernel. Other kernel may also be feasible. However, for example, the theoretical kernel may be a Gaussian kernel with only one free parameter. In this example, the free parameter of the Gaussian kernel may be the full width at half maximum (FWHM).

The system characterization step comprising steps ai) and aii) may comprise using multiple monochromatic light sources with central wavelengths which are spread across the entire wavelength range of the spectrometer device to be characterized. The central wavelength of a monochromatic light source may denote the wavelength in the spectrum of the monochromatic light source having the highest intensity. By way of example, such a monochromatic light source may be realized using a continuous emitter in conjunction with bandpass filters and/or by using a monochromatic emitter, such as a laser or the like. The intrinsic spectral width of the source may preferably be smaller than the line spread function of the spectrometer device at the corresponding wavelength. By comparing the known spectrum of the light that is fed in the spectrometer device and the response of spectrometer device to that illumination, the line spread functions of the spectrometer device at the central wavelengths of the monochromatic light sources may be determined. For example, determining the line spread function may comprise broadening the known high-resolution spectrum using kernel convolution with a theoretical line spread function. The parameters of this theoretical kernel may be adjusted until the broadened reference spectrum matches the spectrum obtained with the spectrometer device to be characterized. The best-fitting function parameters may be used to theoretically approximate the line spread function at this wavelength. The theoretical kernel may be a Gaussian kernel with only one free parameter, specifically the FWHM. Other possible kernel types may comprise Lorentzian profiles, Moffat profiles, or Voigt profiles, wherein the latter two may comprise two free parameters. However, other, in particular asymmetric, kernels may be possible, too. The line spread functions as a function of wavelength across the entire spectral range may be obtained through interpolation between the fit parameters of local estimates from the different monochromatic sources.

Alternatively or additionally, the system characterization step may comprise
aa) illuminating at least one reference object by using at least one broadband light source;
ab) determining the line spread function by comparing a known spectrum of the reference object with the spectrum measured by using the spectrometer device, wherein the known spectrum of the reference object is predetermined by using at least one high-resolution spectrometer.

Step ab) may comprise broadening the known spectrum of the reference object by using kernel convolution with a theoretical line spread function. Step ab) may comprise adjusting parameters of a theoretical kernel until the broadened spectrum of the reference object matches the measured spectrum. The adjusted kernel parameters may be used to approximate the line spread function at this wavelength. The theoretical kernel may be at least one kernel selected from the group consisting of: a Gaussian kernel with only one free parameter; Lorentzian profile; Moffat profile; or Voigt profile; asymmetric kernel.

Step ab) may comprise directly comparing the known spectrum of the reference object with the spectrum measured by using the spectrometer device in signal space and/or comparing at least one derivative of the known spectrum of the reference object with at least one derivative of the spectrum measured by using the spectrometer device, specifically comparing a first-order derivate, a second-order derivative and/or higher order derivatives of the spectra.

The system characterization step comprising steps aa) and ab) may comprise using one or more reference objects for which the intrinsic spectrum may be known, specifically at much higher resolution, and which may be measured beforehand using a high-resolution spectrometer. The higher resolution may refer to the situation where the resolution of the intrinsic spectrum may be higher than the resolution of the spectrometer device to be characterized. By determining the spectrum of these reference objects with the spectrometer device to be characterized and comparing the response of the spectrometer device, specifically of the plurality of photosensitive elements, with the intrinsic spectrum, the line spread functions of the spectrometer device at every wavelength position may be determinable. The mathematical treatment may comprise a convolution with a theoretical kernel, as outlined above. For example, a Gaussian kernel may be used for determining the line spread functions. The comparison may be either be done in signal space or using higher derivatives thereof. This may bear the advantage that constant offsets that are not affected by resolution differences, such as due to straylight in the spectrometer system, may not impact the loss function used to find the optimal line spread functions.

Further, as outlined above, the method may comprise the at least one resolution homogenization step. The term “resolution homogenization” as used herein is a broad term and is to be given its ordinary and customary meaning to a person of ordinary skill in the art and is not to be limited to a special or customized meaning. The term specifically may refer, without limitation, to a process of unifying the system characteristics of the spectrometer device across the batch of spectrometer device. Specifically, the resolution homogenization step may comprise unifying the system characteristics of the spectrometer device determined in the system characterization step. As a result of the resolution homogenization step, the system characteristics of the spectrometer device may be identical to the system characteristics of each other spectrometer device of the batch of spectrometer device. The resolution homogenization step may specifically comprise unifying the spectral resolution of the spectrometer device across the batch of spectrometer device. The resolution homogenization step may comprise using the previously determined is-state of the line spread function of each spectrometer device and computationally converting the is-state of the line spread function to a target state. The is-state of the line spread function may refer to the state of the line spread function being determined in step a), specifically indicating a spectral resolution of the spectrometer device at a specific wavelength. The is-state may specifically an individual state of the spectrometer device. The is-state may be different for different spectrometer devices in the batch of spectrometer devices.

As outlined above, the resolution homogenization step comprises, for each wavelength, converting the resolution of the line spread function to the pre-defined target resolution for a corresponding wavelength, wherein the target resolution for each wavelength is the pre-defined target batch resolution value for the respective wavelength.

The term “target resolution” as used herein is a broad term and is to be given its ordinary and customary meaning to a person of ordinary skill in the art and is not to be limited to a special or customized meaning. The term specifically may refer, without limitation, to a resolution, specifically a resolution as defined above, defining a nominal value for the resolution homogenization step. The target resolution may be wavelength-dependent. The target resolution may be defined for each wavelength of the entire wavelength interval of the spectrometer device. The target resolution may be a fixed target resolution. The target resolution may be identical for each spectrometer device of the batch of spectrometer devices. The target resolution may be lower than the resolution of the individual spectrometer devices of the fleet. This may be required as it is possible to broaden a narrower line spread function, specifically a resolution of the line spread function, to a broader resolution but not vice versa.

The term “target batch resolution value” as used herein is a broad term and is to be given its ordinary and customary meaning to a person of ordinary skill in the art and is not to be limited to a special or customized meaning. The term specifically may refer, without limitation, to a target resolution being identical for each spectrometer device of the batch of spectrometer devices.

The target resolution and the target batch resolution value are predefined. The term “predefined”, as used herein, may refer, without limitation, to a situation in which the target resolution and/or the target batch resolution value may be known and/or determined prior to the performance of the method. In other words, the target resolution and/or the target batch resolution value may be defined in advance of the performance of the method.

The pre-defined target batch resolution value A_{λ,target} may be selected such that the converted resolution A_{λ,conv} for a respective wavelength of the spectrometer device satisfies A_{λ,conv}≤A_{λ,target}.

The converting of the respective resolution A_{λ,meas} of the line spread function to a pre-defined target resolution may comprise convolving the measured spectrum with at least one Kernel with a width described by a quadratic subtraction A_{λ,conv}=\sqrt{(A_{λ,target}²−A_{λ,meas}²)}.

For example, the line spread function may be a Gaussian function with a measured full width half maximum FWHM_{λ} at wavelength λ and the pre-defined target batch resolution value may be a pre-defined full width half maximum FWHM_{λ,target}. The converting may comprise convolving the measured spectrum with a Gaussian kernel of a width described by the quadratic subtraction FWHM_{λ,conv}=\sqrt{(FWHM_{λ,target}²−FWHM_{λ,target}²)}.

In this example, the pre-defined target batch resolution value may be a fleet-wide target resolution value. The homogenized spectrum data point S_{λ} at wavelength λ may be obtained by broadening or convolving the measured spectrum with a Gaussian kernel of the width FWHM_{λ,conv}. This way all FWHM_{λ} of all spectrometer devices in the batch of spectrometer device satisfying FWHM_{λ}<FWHM_{λ,target} may be homogenized to the same resolution FWHM_{λ,target}.

In a further aspect of the present invention, a system for calibrating a spectrometer device of a batch of spectrometer devices is disclosed. The system comprises the spectrometer device comprising at least one detector device. The detector device comprises at least one optical element configured for separating incident light into a spectrum of constituent wavelength components. The detector device further comprises a plurality of photosensitive elements. Each photosensitive element is configured for receiving at least a portion of one of the constituent wavelength components and for generating a respective detector signal depending on an illumination of the respective photosensitive element by the at least one portion of the respective constituent wavelength component. The system further comprises at least one evaluation unit. The evaluation unit is configured for performing the method for calibrating a spectrometer device of a batch of spectrometer devices according to the present invention, such as according to any one of the embodiments disclosed above and/or according to any one of the embodiment disclosed in further detail below.

For definitions and possible embodiments of the system or parts thereof, reference is made to the definitions and embodiments as described with respect to the method for calibrating a spectrometer device of a batch of spectrometer devices.

The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components parts forming a whole. Specifically, the components may interact with each other in order to fulfill at least one common function. The components of the system may be handled independently or may be coupled or connectable. For example, the system may be a single unit, wherein, for example, the spectrometer device and the evaluation unit may form a coupled or connectable unit. Alternatively or additionally, the system may be a distributed system, wherein, for example, the spectrometer device and the evaluation unit may be handled independent from each other but may communicate with each other via a communication net-work. As an example, the evaluation unit may form part of a cloud computer network, wherein the spectrometer device may be configured for communication with the evaluation unit in the cloud computer network.

The term “evaluation unit” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the evaluation unit may be configured for processing basic instructions that drive the computer or system. As an example, the evaluation unit may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the evaluation unit may be or may comprise a central processing unit (CPU). For example, the evaluation unit may comprise one or more processors. Additionally or alternatively, the evaluation unit may be or may comprise a microprocessor. Specifically the evaluation unit's elements may be contained in one single integrated circuitry (IC) chip. Additionally or alternatively, the evaluation unit may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The evaluation unit may specifically be configured, such as by software programming, for performing one or more evaluation operations, specifically one or more operations performed in step a) and/or b) of the method as described in further detail above. The evaluation unit may be configured for, unidirectionally and/or bidirectionally, exchanging data and/or control commands with other elements of the system, specifically with the detector device. Specifically, the evaluation unit may be configured for receiving the plurality of detector signals from the detector device.

The evaluation unit may specifically comprise at least one data storage unit configured for storing at least one of the reference spectrum and the target resolution. Alternatively or additionally, the evaluation unit may comprise at least one retrieving interface configured for retrieving at least one of the reference spectrum and the target resolution, specifically for retrieving at least one of the reference spectrum and the target resolution from a cloud computer network.

The term “data storage unit” as used herein is a broad term and is to be given its ordinary and customary meaning to a person of ordinary skill in the art and is not to be limited to a special or customized meaning. The term specifically may refer, without limitation, to an arbitrary memory device configured to store data. Specifically, the data storage unit may be an electronic, magnetic and/or mechanic memory device. The data storage unit may further be configured to store data, specifically in an organized way, such as in a database, more specifically in at least one database record.

The term “retrieving interface” as used herein is a broad term and is to be given its ordinary and customary meaning to a person of ordinary skill in the art and is not to be limited to a special or customized meaning. The term specifically may refer, without limitation, to an element or device which is configured for retrieving information, such as for the purpose of unidirectionally or bidirectionally exchanging information, such as for exchange of one or more of data or commands. For example, the retrieving interface may be configured to share information stored in a data storage with another device, specifically with the evaluation unit. The retrieving interface may comprise a data interface, such as a wireless and/or a wire-bound data interface.

The system may further comprise at least one broadband light source and at least one optical interferometer arranged to illuminate the spectrometer device with the broadband light source through the optical interferometer. The broadband light source and/or the optical interferometer may be embodied as defined above in the context of the method. In this configuration, the system may be configured for performing steps a1) to a3) of the method for calibrating a spectrometer device of a batch of spectrometer devices according to the present invention, such as according to any one of the embodiments disclosed above and/or according to any one of the embodiment disclosed in further detail below.

Alternatively or additionally, the system may further comprise at least one reference object and the at least one broadband light source. In this configuration, the system may be configured for performing steps aa) and ab) of the method for calibrating a spectrometer device of a batch of spectrometer devices according to the present invention, such as according to any one of the embodiments disclosed above and/or according to any one of the embodiment disclosed in further detail below. As explained above, the broadband light source may comprise at least one of: an incandescent lamp; a blackbody radiator; an electric filament; a light emitting diode.

Alternatively or additionally, the system may further comprise monochromatic light sources with central wavelengths which are spread across a wavelength range of the spectrometer device to be calibrated. In this configuration, the system may be configured for performing steps ai) and aii) of the method for calibrating a spectrometer device of a batch of spectrometer devices according to the present invention, such as according to any one of the embodiments disclosed above and/or according to any one of the embodiment disclosed in further detail below.

The optical element may comprise at least one wavelength selective element. The term “wavelength selective element” as used herein is a broad term and is to be given its ordinary and customary meaning to a person of ordinary skill in the art and is not to be limited to a special or customized meaning. The term specifically may refer, without limitation, to an optical element configured for selectively transmitting light of different wavelengths. Specifically, the wavelength selective element may be configured for transmitting an incident light beam, whereby a spectral composition of the incident light may be modified upon transmission. The modification of the transmitted light may comprise one or more of: a spatial separation of light having different wavelengths; an attenuation of light having different wavelengths. For example, the wavelength selective element may be configured for selectively transmitting light in a particular range of wavelengths, while absorbing, filtering and/or interfering the remainder. The wavelength selective element may comprise at least one element selected from the group consisting of: a prism; a grating; a linear variable filter; an optical filter.

The detector device may comprise the plurality of photosensitive elements arranged in a linear array. The linear array of photosensitive elements may comprise a number of 10 to 1000 photosensitive elements, specifically a number of 100 to 500 photosensitive elements, specifically a number of 200 to 300 photosensitive elements, more specifically a number of 256 photosensitive elements, most specifically a number of 128 photosensitive elements.

Each photosensitive element may comprise at least one element selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising PbS, PbSe, Ge, InGaAs, ext. InGaAs, InSb, Si or HgCdTe.

Each photosensitive element may be sensitive for electromagnetic radiation in wavelength range from 600 nm to 1000 μm, specifically in a wavelength range from 760 nm to 15 μm, more specifically in a wavelength range from 1 μm to 5 μm, more specifically in a wavelength range from 1 μm to 3 μm.

The detector device, specifically during calibration of the detector device, may be comprised by the spectrometer device, specifically by at least one of a reflection spectrometer device and a transmission spectrometer device.

In a further aspect of the present invention, a computer program is disclosed comprising instructions which, when the program is executed by the system according to the present invention, such as according to any one of the embodiments disclosed above and/or according to any one of the embodiments disclosed in further detail below, cause the evaluation unit of the system to perform the method for calibrating a spectrometer device of a batch of spectrometer devices according the present invention, such as according to any one of the embodiments disclosed above and/or according to any one of the embodiments disclosed in further detail below.

Specifically, at least method step a) and b) as indicated above may be performed by using the evaluation unit of the system executing the computer program. Similarly, one, more than one or even all of method steps a3), aii) and ab) may be performed by using the evaluation unit of the system executing the computer program. However, one, more than one or even all of method steps a1), a2), ai) and aa) as indicated above may be at least computer controlled and/or supported by evaluation unit of the system executing the computer program.

In a further aspect of the present invention, a computer-readable storage medium, specifically a non-transient computer-readable storage medium, is disclosed comprising instructions which, when the instructions are executed by the system according to the present invention, such as according to any one of the embodiments disclosed above and/or according to any one of the embodiments disclosed in further detail below, cause the evaluation unit of the system to perform the method for calibrating a spectrometer device of a batch of spectrometer devices according to the present invention, such as according to any one of the embodiments disclosed above and/or according to any one of the embodiments disclosed in further detail below.

As used herein, the term “computer-readable storage medium” specifically may refer to non-transitory data storage means, such as a hardware storage medium having stored thereon computer-executable instructions. The computer-readable storage medium, also referred to as computer-readable data carrier, specifically may be or may comprise a storage medium such as a random-access memory (RAM) and/or a read-only memory (ROM).

The method and system according to the present invention may provide a large number of advantages over known methods and devices. Specifically, the method and the system according to the present invention may provide a global, use-case-independent calibration and correction scheme on the individual spectrometer device level that enables fleet homogenization of the resulting spectral data to the degree that trainable models produce accurate results across the entire fleet of spectrometer devices. Specifically, by using the method and the system according to the present invention, spectral homogeneity through system characterization and controlled degradation may be achieved for all spectrometer device of a batch of spectrometer devices.

The method and the system may use a standardized, use-case-independent testing procedure which is capable of characterizing the spectrometer device followed by a digital postprocessing that treats data from different spectrometer devices in a manner such that identical system characteristics may be emulated.

Summarizing and without excluding further possible embodiments, the following embodiments may be envisaged:

Embodiment 1: A method for calibrating a spectrometer device of a batch of spectrometer devices, wherein the spectrometer device comprises at least one detector device comprising at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component, wherein the method comprises the following steps:
a) at least one system characterization step comprising determining line spread functions at corresponding wavelengths by comparing at least one spectrum measured by using the spectrometer device with at least one reference spectrum;
b) at least one resolution homogenization step comprising for each wavelength converting a resolution of the line spread function to a pre-defined target resolution for a corresponding wavelength, wherein the target resolution for each wavelength is a pre-defined target batch resolution value for the respective wavelength.

Embodiment 2: The method according to the preceding embodiment, wherein the pre-defined target batch resolution value A_{λ,target} is selected such that the converted resolution A_{λ,conv} for a respective wavelength of the spectrometer device satisfies A_{λ,conv}≤A_{λ,target}.

Embodiment 3: The method according to any one of the preceding embodiments, wherein the converting of the respective resolution A_{λ,meas} of the line spread function to a pre-defined target resolution comprises convolving the measured spectrum with at least one Kernel with a width described by a quadratic subtraction A_{λ,conv}=\sqrt{(A_{λ,target}²−A_{λ,meas}²)}.

Embodiment 4: The method according to any one of the preceding embodiments, wherein the line spread function is a Gaussian function with a measured full width half maximum FWHMλ at wavelength λ and the pre-defined target batch resolution value is a pre-defined full width half maximum FWHMλ,target, wherein the converting comprises convolving the measured spectrum with a Gaussian kernel of a width described by the quadratic subtraction FWHM_{λ,conv}=\sqrt{(FWHM_{λ,target}²−FWHM_{λ,target}²)}.

Embodiment 5: The method according to any one of the preceding embodiments, wherein the line spread function describes a distribution of responses of the plurality of photosensitive elements to incident light having a specific wavelength.

Embodiment 6: The method according to any one of the preceding embodiments, wherein the system characterization step comprises
a1) illuminating, by using at least one broadband light source, the spectrometer device through at least one optical interferometer;
a2) determining for the plurality of photosensitive elements a plurality of detectors signals depending on the illumination through the optical interferometer in step a1); and
a3) determining the line spread function from the plurality of detector signals.

Embodiment 7: The method according to the preceding embodiment, wherein the optical interferometer comprises at least one interferometer selected from the group consisting of: a Michelson interferometer; a Fabry-Pérot interferometer; a cube corner interferometer.

Embodiment 8: The method according to any one of the two preceding embodiments, wherein in step a1), a main frequency of the optical interferometer, specifically a main transmission frequency and/or a main reflection frequency of the optical interferometer, is varied over a predetermined spectral range, and wherein, in step a2), the plurality of detectors signals is determined depending on the main frequency of the optical interferometer.

Embodiment 9: The method according to the preceding embodiment, wherein, in step a 3), the line spread function is determined by comparing the main frequency of the optical interferometer, specifically the main transmission frequency and/or the main reflection frequency of the optical interferometer, with at least one of a pixel position and an identification number of the plurality of photosensitive elements generating intensity peaks in the plurality of detector signals associated with the main frequency.

Embodiment 10: The method according to any one of the four preceding embodiments, wherein the optical interferometer comprises at least one beam splitting device for splitting incident light into at least two illumination paths, wherein the optical interferometer further comprises at least one scanning mirror in a first illumination path and at least one stationary mirror in a second illumination path, wherein, in the method, the scanning mirror is moved along the first illumination path, wherein the stationary mirror is kept stationary.

Embodiment 11: The method according to the preceding embodiment, wherein in step a2), the plurality of detector signals is determined for a plurality of positions of the scanning mirror in the first illumination path, wherein the plurality of positions of the scanning mirror are different from each other, wherein step a3) comprises correlating the plurality of detector signals with the plurality of positions of the scanning mirror, wherein, in step a3), the plurality of detector signals correlated to the plurality of positions of the scanning mirror is used for determining the line spread function.

Embodiment 12: The method according to any one of the six preceding embodiments, wherein step a3) comprises processing the plurality of detector signals determined in the step a2), thereby obtaining a plurality of processed detector signals, wherein the determining of the line spread function in step a3) comprises determining the line spread function from the plurality of processed detector signals, wherein the processing of the plurality of detector signals comprises transforming the plurality of detector signals, wherein the plurality of detector signals is transformed by using at least one Fourier transformation.

Embodiment 13: The method according to any one of the preceding embodiments, wherein the system characterization step comprises
ai) illuminating the spectrometer device by using monochromatic light sources with central wavelengths which are spread across a wavelength range of the spectrometer device to be calibrated;
aii) determining the line spread function by comparing a known spectrum of the monochromatic light sources with the spectrum measured by using the spectrometer device.

Embodiment 14: The method according to the preceding embodiment, wherein the monochromatic light sources comprise a continuous emitter in conjunction with bandpass filters or a monochromatic emitter.

Embodiment 15: The method according to any one of the two preceding embodiments, wherein an intrinsic spectral width of the monochromatic light sources is comparable to the line spread function at the corresponding wavelength.

Embodiment 16: The method according to any one of the three preceding embodiments, wherein step aii) comprises broadening the known spectrum of the monochromatic light sources by using kernel convolution with a theoretical line spread function, wherein step aii) comprises adjusting parameters of a theoretical kernel until the broadened spectrum of the monochromatic light sources matches the measured spectrum, wherein the adjusted kernel parameters are used to approximate the line spread function at this wavelength.

Embodiment 17: The method according to the preceding embodiment, wherein the theoretical kernel is at least one kernel selected from the group consisting of: a Gaussian kernel with only one free parameter; Lorentzian profile; Moffat profile; or Voigt profile; asymmetric kernel.

Embodiment 18: The method according to any one of the preceding embodiments, wherein the system characterization step comprises
aa) illuminating at least one reference object by using at least one broadband light source;
ab) determining the line spread function by comparing a known spectrum of the reference object with the spectrum measured by using the spectrometer device, wherein the known spectrum of the reference object is predetermined by using at least one high-resolution spectrometer.

Embodiment 19: The method according to the preceding embodiment, wherein step ab) comprises broadening the known spectrum of the reference object by using kernel convolution with a theoretical line spread function, wherein step ab) comprises adjusting parameters of a theoretical kernel until the broadened spectrum of the reference object matches the measured spectrum, wherein the adjusted kernel parameters are used to approximate the line spread function at this wavelength.

Embodiment 20: The method according to any one of the two preceding embodiments, wherein step ab) comprises directly comparing the known spectrum of the reference object with the spectrum measured by using the spectrometer device in signal space and/or comparing at least one derivative of the known spectrum of the reference object with at least one derivative of the spectrum measured by using the spectrometer device, specifically comparing a first-order derivate, a second-order derivative and/or higher order derivatives of the spectra.

Embodiment 21: A system for calibrating a spectrometer device of a batch of spectrometer devices, wherein the system comprises the spectrometer device comprising at least one detector device, wherein the detector device comprises at least one optical element configured for separating incident light into a spectrum of constituent wavelength components and further comprising a plurality of photosensitive elements, wherein each photosensitive element is configured for receiving at least a portion of one of the constituent wavelength components and for generating a respective detector signal depending on an illumination of the respective photosensitive element by the at least one portion of the respective constituent wavelength component, wherein the system further comprises at least one evaluation unit, wherein the evaluation unit is configured for performing the method for calibrating a spectrometer device of a batch of spectrometer devices according to any one of the preceding embodiments.

Embodiment 22: The system according to the preceding embodiment, wherein the evaluation unit comprises at least one data storage unit configured for storing at least one of the reference spectrum and the target resolution.

Embodiment 23: The system according to any one of the preceding embodiments referring to a system, wherein the evaluation unit comprises at least one retrieving interface configured for retrieving at least one of the reference spectrum and the target resolution, specifically for retrieving at least one of the reference spectrum and the target resolution from a cloud computer net-work.

Embodiment 24: The system according to any one of the preceding embodiments referring to a system, wherein the system further comprises at least one broadband light source and at least one optical interferometer arranged to illuminate the spectrometer device with the broadband light source through the optical interferometer.

Embodiment 25: The system according to any one of the preceding embodiments referring to a system, wherein the system further comprises at least one reference object and at least one broadband light source.

Embodiment 26: The system according to any one of the two preceding embodiments, wherein the broadband light source comprises at least one of: an incandescent lamp; a blackbody radiator; an electric filament; a light emitting diode.

Embodiment 27: The system according to any one of the preceding embodiments referring to a system, wherein the system further comprises monochromatic light sources with central wavelengths which are spread across a wavelength range of the spectrometer device to be calibrated.

Embodiment 28: The system according to any one of the preceding embodiments referring to a system, wherein the optical element comprises at least one wavelength selective element, wherein the wavelength selective element comprises at least one element selected from the group consisting of: a prism; a grating; a linear variable filter; an optical filter.

Embodiment 29: The system according to any one of the preceding embodiments referring to a system, wherein the detector device comprises the plurality of photosensitive elements arranged in a linear array, wherein the linear array of photosensitive elements comprises a number of 10 to 1000 photosensitive elements, specifically a number of 100 to 500 photosensitive elements, specifically a number of 200 to 300 photosensitive elements, more specifically a number of 256 photosensitive elements, most specifically a number of 128 photosensitive elements.

Embodiment 30: The system according to any one of the preceding embodiments referring to a system, wherein each photosensitive element comprises at least one element selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising PbS, PbSe, Ge, InGaAs, ext. InGaAs, InSb, Si or HgCdTe.

Embodiment 31: The system according to any one of the preceding embodiments referring to a system, wherein each photosensitive element is sensitive for electromagnetic radiation in wavelength range from 600 nm to 1000 μm, specifically in a wavelength range from 760 nm to 15 μm, more specifically in a wavelength range from 1 μm to 5 μm, more specifically in a wavelength range from 1 μm to 3 μm.

Embodiment 32: The system according to any one of the preceding embodiments referring to a system, wherein the detector device is comprised by the spectrometer device, specifically by at least one of a reflection spectrometer device and a transmission spectrometer device.

Embodiment 33: A computer program comprising instructions which, when the program is executed by the system according to any one of the preceding embodiments referring to a system, cause the evaluation unit of the system to perform the method for calibrating a spectrometer device of a batch of spectrometer devices according to any one of the preceding embodiments referring to a method.

Embodiment 34: A computer-readable storage medium, specifically a non-transient computer-readable storage medium, comprising instructions which, when the instructions are executed by the system according to any one of the preceding embodiments referring to a system, cause the evaluation unit of the system to perform the method for calibrating a spectrometer device of a batch of spectrometer devices according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the figures:

FIGS. 1A to 1C show embodiments of a system for calibrating a spectrometer device of a batch of spectrometer devices in a schematic view;

FIGS. 2A to 2C show embodiments of a method for calibrating a spectrometer device of a batch of spectrometer devices;

FIG. 3 shows an exemplary spectrum measured by using a spectrometer device;

FIG. 4 shows an exemplary line spread function; and

FIG. 5 shows exemplary spectra measured by using two different spectrometer devices.

### DETAILED DESCRIPTION OF THE EMBODIMENTS

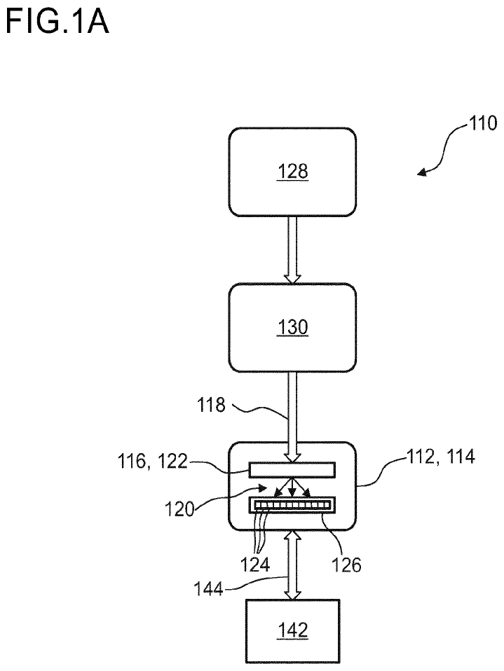

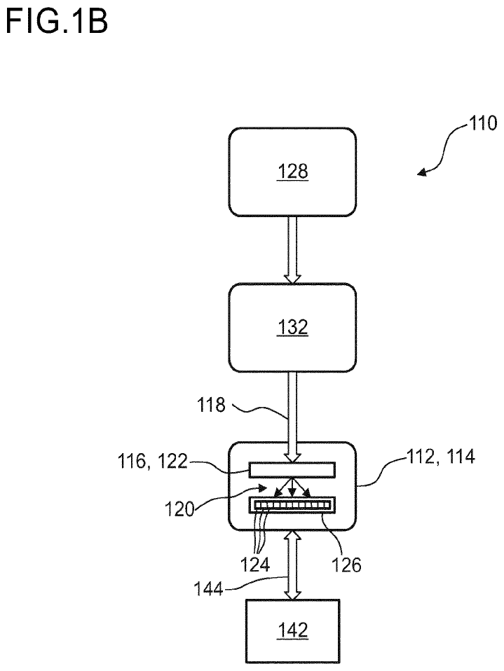

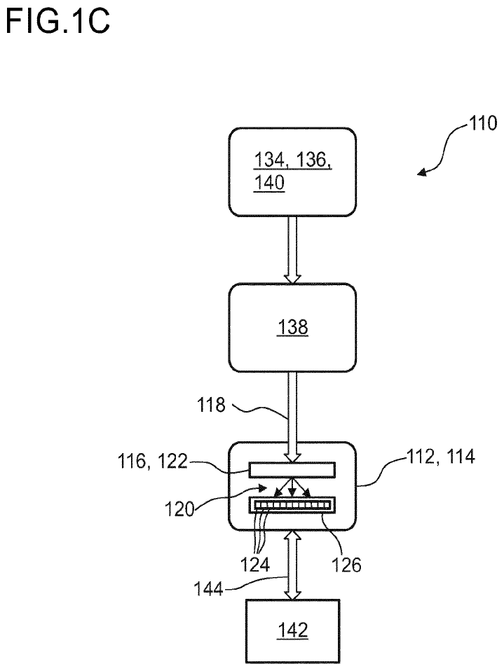

FIGS. 1A to 1C show exemplary embodiments of a system 110 for calibrating a spectrometer device 112 of a batch of spectrometer devices 112 in a schematic view. The embodiments of FIGS. 1A to 1C may widely correspond to each other. In the following, FIGS. 1A to 1C are described in conjunction.

The system 110 comprises the spectrometer device 112 and at least one detector device 114. The detector device 114 comprises at least one optical element 116 configured for separating incident light 118 into a spectrum of constituent wavelength components 120. The optical element 116 may specifically comprise at least one wavelength selective element 122. For example, the wavelength selective element 122 may comprise at least one element selected from the group consisting of: a prism; a grating; a linear variable filter; an optical filter.

Further, the detector device 114 comprises a plurality of photosensitive elements 124, wherein each photosensitive element 124 is configured for receiving at least a portion of one of the constituent wavelength components 120 and for generating a respective detector signal depending on an illumination of the respective photosensitive element 124 by the at least one portion of the respective constituent wavelength component 120. As shown in FIGS. 1A to 1C, the detector device 114 may comprise the plurality of photosensitive elements 124 arranged in a linear array 126. In the exemplary embodiments of FIGS. 1A to 1C, the linear array 126 of photosensitive elements 124 may comprise a number of 128 photosensitive elements 124. Each photosensitive element 124 may comprise at least one element selected from the group consisting of: a pixelated inorganic camera element, specifically a pixelated inorganic camera chip, more specifically a CCD chip or a CMOS chip; a monochrome camera element, specifically a monochrome camera chip; at least one photoconductor, specifically an inorganic photoconductor, more specifically an inorganic photoconductor comprising PbS, PbSe, Ge, InGaAs, ext. InGaAs, InSb, Si or HgCdTe. Each photosensitive element 124 may be sensitive for electromagnetic radiation in wavelength range from 600 nm to 1000 μm, specifically in a wavelength range from 760 nm to 15 μm, more specifically in a wavelength range from 1 μm to 5 μm, more specifically in a wavelength range from 1 μm to 3 μm.

In the embodiment of FIG. 1A, the system 110 may further comprise at least one broadband light source 128 and at least one optical interferometer 130 arranged to illuminate the spectrometer device 112 with the broadband light source 128 through the optical interferometer 130. The broadband light source 128 may comprise, for example, at least one of: an incandescent lamp; a blackbody radiator; an electric filament; a light emitting diode. The optical interferometer 130 may comprise at least one interferometer selected from the group consisting of: a Michelson interferometer; a Fabry-Pérot interferometer; a cube corner interferometer. For further details of the optical interferometer 130, reference is made to the description above.

In the embodiment of FIG. 1B, the system 110 may also comprise the at least one broadband light source 128. However, in this embodiment, the system 110 may further comprise at least one reference object 132. The reference object 132 may specifically be an object of known spectral characteristics, such as known reflection and/or transmission characteristics.

In the embodiment of FIG. 1C, the system 110 may further comprise monochromatic light sources 134 with central wavelengths which are spread across a wavelength range of the spectrometer device 112 to be calibrated. The system 110 may specifically comprise a plurality of monochromatic light sources 134. The monochromatic light sources 134 may comprise a continuous emitter 136, such as the broadband light source 128, in conjunction with bandpass filters 138 or a monochromatic emitter 140, such as a laser or the like. In case of the monochromatic emitter 140, the system 110 may not comprise any additional element in between the emitter 140 and the spectrometer device 112. An intrinsic spectral width of the monochromatic light sources 134 may be comparable to a line spread function of the spectrometer device 112 at the corresponding wavelength.

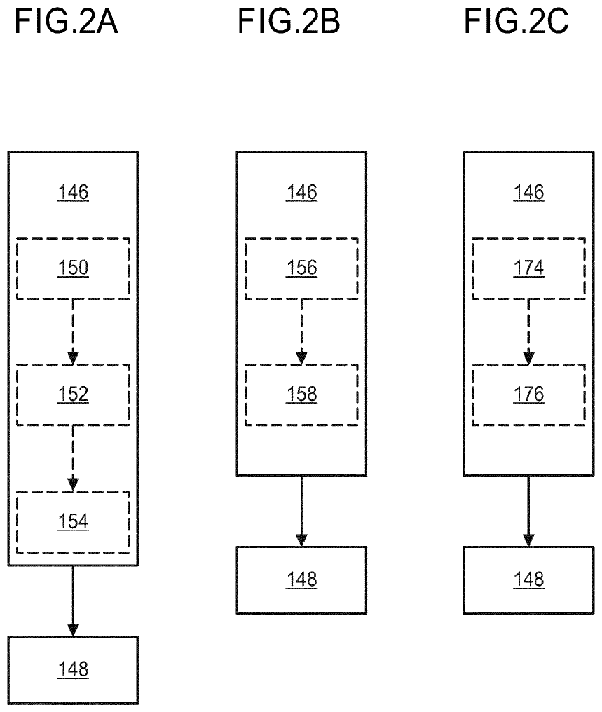

As shown in FIGS. 1A to 1C, the system 110 further comprises at least one evaluation unit 142. The evaluation unit 142 is configured for performing the method for calibrating a spectrometer device 112 of a batch of spectrometer devices 112 according to the present invention, such as according any one of the embodiments described with respect to FIG. 2A to 2C. For a description of the method, reference is made to the description of FIGS. 2A to 2C. However, the evaluation unit 142 may also be configured for performing the method for calibrating a spectrometer device 112 of a batch of spectrometer devices 112 according to the present invention in any other embodiment disclosed herein. As indicated by arrow 144 in FIGS. 1A to 1C, the spectrometer device 112, specifically the detector device 114, may be configured for communicating with the evaluation unit 142, specifically for communicating the detector signals to the evaluation unit 142.

FIGS. 2A to 2C show exemplary embodiments of a method for calibrating a spectrometer device 112 of a batch of spectrometer devices 112. For possible embodiments of the spectrometer device 112, reference is made to FIGS. 1A to 1C and the corresponding description. The embodiments of the method shown in FIGS. 2A to 2C widely correspond to each other. In the following, FIGS. 2A to 2C are described in conjunction.

The method comprises the following step:
a) (denoted by reference number 146) at least one system characterization step comprising determining line spread functions at corresponding wavelengths by comparing at least one spectrum measured by using the spectrometer device 112 with at least one reference spectrum;
b) (denoted by reference number 148) at least one resolution homogenization step comprising for each wavelength converting a resolution of the line spread function to a pre-defined target resolution for a corresponding wavelength, wherein the target resolution for each wavelength is a pre-defined target batch resolution value for the respective wavelength.

These steps, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

For the exemplary embodiment of the method shown FIG. 2A, the system 110 as shown in the embodiment of FIG. 1A may be used. In this example, the system characterization step 146 may comprise:
a1) (denoted by reference number 150) illuminating, by using the at least one broadband light source 128, the spectrometer device 112 through the at least one optical interferometer 130;
a2) (denoted by reference number 152) determining for the plurality of photosensitive elements 124 a plurality of detectors signals depending on the illumination through the optical interferometer 130 in step a1); and
a3) (denoted by reference number 154) determining the line spread function from the plurality of detector signals.

In step a1), a main frequency of the optical interferometer 130, specifically a main transmission frequency and/or a main reflection frequency of the optical interferometer 130, may be varied over a predetermined spectral range. In step a2), the plurality of detectors signals may be determined depending on the main frequency of the optical interferometer 130. In step a3), the line spread function may be determined by comparing the main frequency of the optical interferometer 130, specifically the main transmission frequency and/or the main reflection frequency of the optical interferometer 130, with at least one of a pixel position and an identification number of the plurality of photosensitive elements 124 generating intensity peaks in the plurality of detector signals associated with the main frequency.

The optical interferometer 130 may, as an example, comprise at least one beam splitting device for splitting incident light into at least two illumination paths. The optical interferometer 130 may further comprise at least one scanning mirror in a first illumination path and at least one stationary mirror in a second illumination path (not shown in FIG. 1A). In the method, specifically in steps a1) and a2), the scanning mirror may be moved along the first illumination path, wherein the stationary mirror may be kept stationary. Specifically, in step a2), the plurality of detector signals may be determined for a plurality of positions of the scanning mirror in the first illumination path. The plurality of positions of the scanning mirror may be different from each other. Step a3) may further comprise correlating the plurality of detector signals with the plurality of positions of the scanning mirror. Specifically, in step a3), the plurality of detector signals correlated to the plurality of positions of the scanning mirror may be used for determining the line spread function.

Step a3) may comprise processing the plurality of detector signals determined in the step a2), thereby obtaining a plurality of processed detector signals. The determining of the line spread function in step a3) may comprise determining the line spread function from the plurality of processed detector signals. The processing of the plurality of detector signals may specifically comprise transforming the plurality of detector signals. As an example, the plurality of detector signals may be transformed by using at least one Fourier transformation.

For the exemplary embodiment of the method shown FIG. 2B, the system 110 as shown in the embodiment of FIG. 1B may be used. In this example, the system characterization step 146 may comprise:
aa) (denoted by reference number 156) illuminating the at least one reference object 132 by using the at least one broadband light source 128;
ab) (denoted by reference number 158) determining the line spread function by comparing a known spectrum of the reference object 132 with the spectrum measured by using the spectrometer device 112, wherein the known spectrum of the reference object 132 is predetermined by using at least one high-resolution spectrometer.

Step ab) may comprise broadening the known spectrum of the reference object 132 by using kernel convolution with a theoretical line spread function. Step ab) may comprise adjusting parameters of a theoretical kernel until the broadened spectrum of the reference object 132 matches the measured spectrum. The adjusted kernel parameters may be used to approximate the line spread function at this wavelength. The theoretical kernel may be at least one kernel selected from the group consisting of: a Gaussian kernel with only one free parameter; Lorentzian profile; Moffat profile; or Voigt profile; asymmetric kernel.

Step ab) may comprise directly comparing the known spectrum of the reference object 132 with the spectrum measured by using the spectrometer device 112 in signal space and/or comparing at least one derivative of the known spectrum of the reference object 132 with at least one derivative of the spectrum measured by using the spectrometer device 112, specifically comparing a first-order derivate, a second-order derivative and/or higher order derivatives of the spectra.

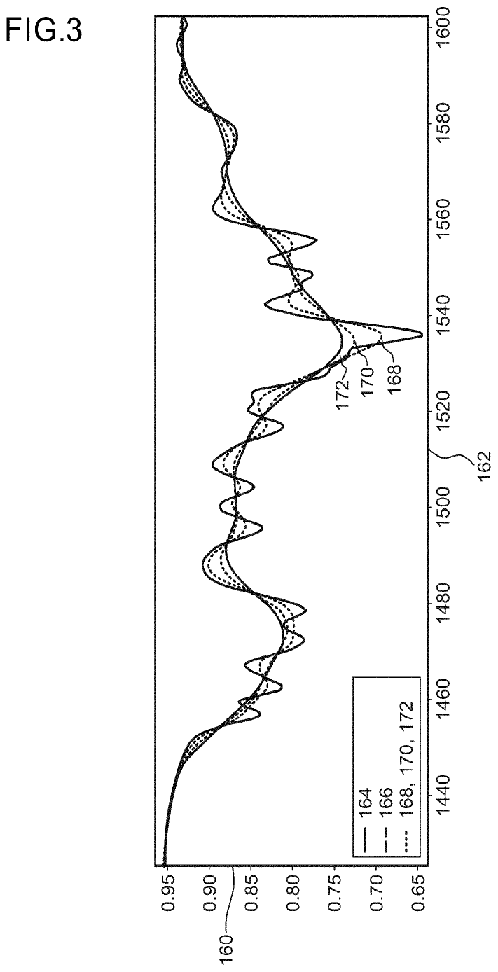

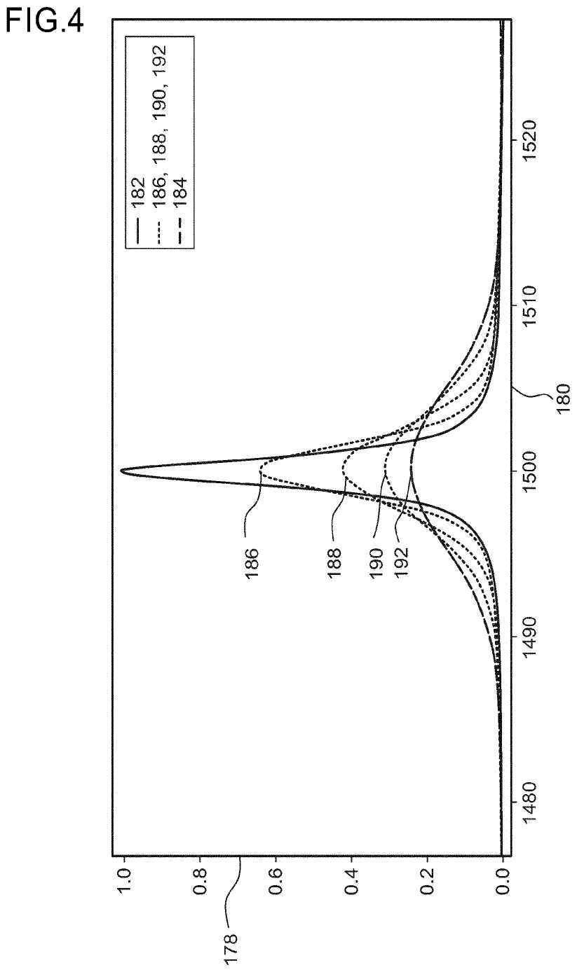

An exemplary result of steps aa) and ab) is shown in FIG. 3. Specifically, FIG. 3 shows a diagram with a reflectance 160 as a function of wavelength 162, the wavelength 162 being measured in nm. FIG. 3 shows an exemplary known spectrum 164 of the reference object 132, in this example a rare earth wavelength standard, the known spectrum 164 being measured with the high-resolution spectrometer, in this example a Bruker® MPA spectrometer. FIG. 3 further shows the spectrum of the reference object 132 measured by using the spectrometer device 112 (denoted by reference number 166) and broadened known spectra of the reference object 132 by using a Gaussian kernel convolution with a FWHM of 5 nm (denoted by reference number 166), with a FWHM of 10 nm (denoted by reference number 168) and with a FWHM of 15 nm (denoted by reference number 166). As can be seen in FIG. 4, the best result is achieved by broadening with a FWHM of 15 nm. The line spread function in this wavelength region may be approximated with a Gaussian kernel with a FWHM of 15 nm.

For the exemplary embodiment of the method shown FIG. 2C, the system 110 as shown in the embodiment of FIG. 1C may be used. In this example, the system characterization step 146 may comprise:
ai) (denoted by reference number 174) illuminating the spectrometer device 112 by using monochromatic light sources 134 with central wavelengths which are spread across a wavelength range of the spectrometer device 112 to be calibrated;
aii) (denoted by reference number 176) determining the line spread function by comparing a known spectrum of the monochromatic light sources 134 with the spectrum measured by using the spectrometer device 112.

Step aii) may comprise broadening the known spectrum of the monochromatic light sources 134 by using kernel convolution with a theoretical line spread function. Step aii) may specifically comprise adjusting parameters of a theoretical kernel until the broadened spectrum of the monochromatic light sources 134 matches the measured spectrum. The adjusted kernel parameters may be used to approximate the line spread function at this wavelength. The theoretical kernel may be at least one kernel selected from the group consisting of: a Gaussian kernel with only one free parameter; Lorentzian profile; Moffat profile; or Voigt profile; asymmetric kernel. Other kernel may also be feasible. However, for example, the theoretical kernel may be a Gaussian kernel with only one free parameter. In this example, the free parameter of the Gaussian kernel may be the full width at half maximum (FWHM).

An exemplary result of steps ai) and aii) is shown in FIG. 4. Specifically, FIG. 4 shows a diagram with relative signal intensity 178 as a function of wavelength 180, the wavelength 180 being measured in nm. In FIG. 4, the known spectrum 182 of the monochromatic light source 134, here a monochromatic light source at 1500 nm, the spectrum 184 of the monochromatic light source 134 measured by using the spectrometer device 112 and multiple broadened spectra 186, 188, 190 are shown. The broadened spectra 186, 188, 190 of FIG. 4 may be obtained by broadening the known spectrum 182 of the monochromatic light source 134 by using Gaussian kernel convolution, specifically with a FWHM of 2.5 nm (denoted by reference number 186), with a FWHM of 5 nm (denoted by reference number 188), with a FWHM of 7.5 nm (denoted by reference number 190) and with a FWHM of 10 nm (denoted by reference number 192). As can be seen in FIG. 4, a convolution with a Gaussian kernel with a FWHM of 10 nm represents the measured spectrum 184 best. The line spread function may be approximated by a Gaussian with 10 nm FWHM at a wavelength of 1500 nm.

Turing back to FIGS. 2A to 2C, in the resolution homogenization step, the pre-defined target batch resolution value A_{λ,target} may be selected such that the converted resolution A_{λ,conv} for a respective wavelength of the spectrometer device 112 satisfies A_{λ,conv}≤A_{λ,target}. Specifically, the converting of the respective resolution A_{λ,meas} of the line spread function to a pre-defined target resolution may comprise convolving the measured spectrum with at least one Kernel with a width described by a quadratic subtraction A_{λ,conv}=\sqrt{(A_{λ,target}²−A_{λ,meas}²)}.

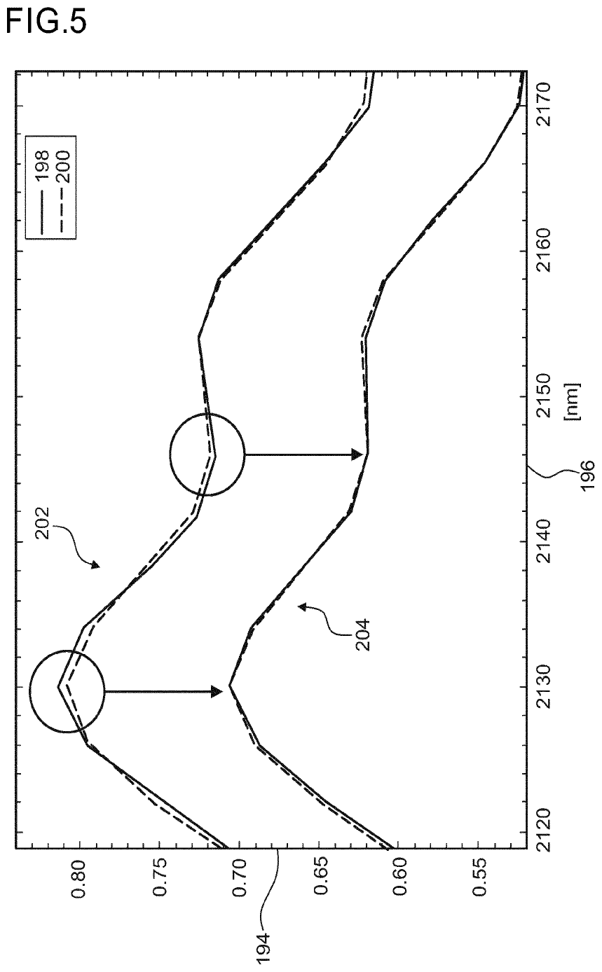

FIG. 5 shows exemplary spectra measured by using two different spectrometer devices 112. The two different spectrometer devices 112 may be spectrometer devices 112 of the same batch of spectrometer devices 112 and, thus, may be embodied similar with respect to each other. The spectrometer devices 112 may specifically be embodied as shown in any one of the FIGS. 1 to 3. Thus, for a detailed description of the spectrometer devices 112 used for measuring the spectra shown in FIG. 5, reference is made to the description of FIGS. 1 to 3. FIG. 5 specifically shows a diagram with a measured absorbance 194 of the sample as a function of wavelength 196. In this example, the measured sample is a polyethylene terephthalate (PET) sample being measured in diffuse reflection. The diagram of FIG. 5 shows a part of the spectra measured by using the spectrometer devices 112, specifically the spectral region around the triple peak of PET around 2150 nm. In FIG. 5, the spectrum measured by a first spectrometer device 112 is denoted by reference number 198 and the spectrum measured by a second spectrometer device 112 is denoted by reference number 200. Although the two spectrometer devices 112 may be of the same batch of spectrometer devices 112, the first spectrometer device 112 may show a higher resolution compared with the second spectrometer device 122. The higher resolution can be seen in FIG. 5 manifested by higher peaks in the spectrum 198 of the first spectrometer device 112 compared with the spectrum 200 of the second spectrometer device 112. The differences in spectra as measured are highlighted in FIG. 5 by circles. Original spectra are indicated by reference number 202 in FIG. 5. FIG. 5 further shows in the same diagram the spectra for both spectrometer devices 112 after performing the resolution homogenization step. The spectra after performing the resolution homogenization step are denoted by reference number 204 and are shifted in the diagram to ease visibility. In the processed spectra 204 after the resolution homogenization step, both spectrometer devices 112 may show the same nominal resolution and thereby show much more similar features.

### LIST OF REFERENCE NUMBERS

110 system
112 spectrometer device
114 detector device
116 optical element
118 incident light
120 constituent wavelength component
122 wavelength selective element
124 photosensitive element
126 linear array
128 broadband light source
130 optical interferometer
132 reference object
134 monochromatic light source
136 continuous emitter
138 bandpass filters
140 monochromatic emitter
142 evaluation unit
144 arrow
146 system characterization step
148 resolution homogenization step
150 illuminating the spectrometer device
152 determining detector signals
154 determining the line spread function
156 illuminating the reference object
158 determining the line spread function
160 reflectance
162 wavelength
164 known spectrum
166 spectrum of the reference object measured by using the spectrometer device
168 broadened known spectra of the reference object with a FWHM of 5 nm
170 broadened known spectra of the reference object with a FWHM of 10 nm
172 broadened known spectra of the reference object with a FWHM of 15 nm
174 illuminating the spectrometer device by using monochromatic light sources
176 determining the line spread function
178 relative signal intensity
180 wavelength
182 known spectrum of the monochromatic light source
184 sectrum of the monochromatic light source measured by using the spectrometer device
186 broadened known spectra of the monochromatic light source with a FWHM of 2.5 nm
188 broadened known spectra of the monochromatic light source with a FWHM of 5 nm
190 broadened known spectra of the monochromatic light source with a FWHM of 7.5 nm
192 broadened known spectra of the monochromatic light source with a FWHM of 10 nm 194 absorbance
196 wavelength
198 spectrum of first spectrometer device
200 spectrum of second spectrometer device
202 original spectra
204 processed spectra

1. A method for calibrating a spectrometer device of a batch of spectrometer devices wherein the spectrometer device comprises at least one detector device comprising at least one optical element configured for separating incident light into a spectrum of constituent wavelength components and further comprising a plurality of photosensitive elements wherein each photosensitive element is configured for receiving at least a portion of one of the constituent wavelength components and for generating a respective detector signal depending on an illumination of the respective photosensitive element by the at least one portion of the respective constituent wavelength component wherein the method comprises the following steps:
a) at least one system characterization step comprising determining line spread functions at corresponding wavelengths by comparing at least one spectrum measured by using the spectrometer device with at least one reference spectrum; and
b) at least one resolution homogenization step comprising for each wavelength converting a resolution of the line spread function to a pre-defined target resolution for a corresponding wavelength, wherein the target resolution for each wavelength is a pre-defined target batch resolution value for the respective wavelength.

2. The method according to claim 1, wherein the pre-defined target batch resolution value A_{λ,target} is selected such that the converted resolution A_{λ,conv} for a respective wavelength of the spectrometer device (112) satisfies A_{λ,conv}≤A_{λ,target}.

3. The method according to claim 1, wherein the converting of the respective resolution A_{λ,meas} of the line spread function to a pre-defined target resolution comprises convolving the measured spectrum with at least one Kernel with a width described by a quadratic subtraction A_{λ,conv}=\sqrt{(A_{λ,target}²−A_{λ,meas}²)}.

4. The method according to claim 1, wherein the system characterization step comprises
a1) illuminating, by using at least one broadband light source the spectrometer device through at least one optical interferometer
a2) determining for the plurality of photosensitive elements a plurality of detectors signals depending on the illumination through the optical interferometer in step a1); and
a3) determining the line spread function from the plurality of detector signals.

5. The method according to claim 4, wherein in step a1), a main frequency of the optical interferometer (is varied over a predetermined spectral range, and wherein, in step a2), the plurality of detectors signals is determined depending on the main frequency of the optical interferometer wherein, in step a3), the line spread function is determined by comparing the main frequency of the optical interferometer with at least one of a pixel position and an identification number of the plurality of photosensitive elements generating intensity peaks in the plurality of detector signals associated with the main frequency.

6. The method according to claim 4, wherein the optical interferometer comprises at least one beam splitting device for splitting incident light into at least two illumination paths, wherein the optical interferometer further comprises at least one scanning mirror in a first illumination path and at least one stationary mirror in a second illumination path, wherein, in the method, the scanning mirror is moved along the first illumination path, wherein the stationary mirror is kept stationary,, wherein in step a2), the plurality of detector signals is determined for a plurality of positions of the scanning mirror in the first illumination path, wherein the plurality of positions of the scanning mirror are different from each other, wherein step a3) comprises correlating the plurality of detector signals with the plurality of positions of the scanning mirror, wherein, in step a3), the plurality of detector signals correlated to the plurality of positions of the scanning mirror is used for determining the line spread function.

7. The method according to claim 4, wherein step a3) comprises processing the plurality of detector signals determined in the step a2), thereby obtaining a plurality of processed detector signals, wherein the determining of the line spread function in step a3) comprises determining the line spread function from the plurality of processed detector signals, wherein the processing of the plurality of detector signals comprises transforming the plurality of detector signals, wherein the plurality of detector signals is transformed by using at least one Fourier transformation.

8. The method according to claim 1, wherein the system characterization step comprises
ai) illuminating the spectrometer device by using monochromatic light sources with central wavelengths which are spread across a wavelength range of the spectrometer device to be calibrated; and
aii) determining the line spread function by comparing a known spectrum of the monochromatic light sources with the spectrum measured by using the spectrometer device.

9. The method according to claim 8, wherein step aii) comprises broadening the known spectrum of the monochromatic light sources by using kernel convolution with a theoretical line spread function, wherein step aii) comprises adjusting parameters of a theoretical kernel until the broadened spectrum of the monochromatic light sources matches the measured spectrum, wherein the adjusted kernel parameters are used to approximate the line spread function at this wavelength.

10. The method according to claim 1, wherein the system characterization step comprises
aa) illuminating at least one reference object by using at least one broadband light source;
ab) determining the line spread function by comparing a known spectrum of the reference object with the spectrum measured by using the spectrometer device wherein the known spectrum of the reference object is predetermined by using at least one high-resolution spectrometer.

11. The method according to claim 10, wherein step ab) comprises broadening the known spectrum of the reference object by using kernel convolution with a theoretical line spread function, wherein step ab) comprises adjusting parameters of a theoretical kernel until the broadened spectrum of the reference object matches the measured spectrum, wherein the adjusted kernel parameters are used to approximate the line spread function at this wavelength.

12. The method according to claim 10, wherein step ab) comprises directly comparing the known spectrum of the reference object with the spectrum measured by using the spectrometer device in signal space and/or comparing at least one derivative of the known spectrum of the reference object with at least one derivative of the spectrum measured by using the spectrometer device specifically comparing a first-order derivate, a second-order derivative and/or higher order derivatives of the spectra.

13. A system for calibrating a spectrometer device of a batch of spectrometer devices wherein the system comprises the spectrometer device comprising at least one detector device wherein the detector device comprises at least one optical element configured for separating incident light into a spectrum of constituent wavelength components and further comprising a plurality of photosensitive elements wherein each photosensitive element is configured for receiving at least a portion of one of the constituent wavelength components and for generating a respective detector signal depending on an illumination of the respective photosensitive element by the at least one portion of the respective constituent wavelength component wherein the system further comprises at least one evaluation unit wherein the evaluation unit is configured for performing the method for calibrating a spectrometer device of a batch of spectrometer devices according to claim 1.

14. A computer program comprising instructions which, when the program is executed by the system according to claim 13 referring to a system cause the evaluation unit of the system to perform the method for calibrating a spectrometer device of a batch of spectrometer devices.

15. A computer-readable storage medium, specifically a non-transient computer-readable storage medium, comprising instructions which, when the instructions are executed by the system according to claim 13, cause the evaluation unit of the system to perform a method for calibrating a spectrometer device of a batch of spectrometer devices comprising the following steps:
a) at least one system characterization step comprising determining line spread functions at corresponding wavelengths by comparing at least one spectrum measured by using the spectrometer device with at least one reference spectrum; and
b) at least one resolution homogenization step comprising for each wavelength converting a resolution of the line spread function to a pre-defined target resolution for a corresponding wavelength, wherein the target resolution for each wavelength is a pre-defined target batch resolution value for the respective wavelength.
